(19) United States
(12) Patent Application Publication
(10) Pub. No.: US 2002/0178035 A1
(43) Pub. Date: Nov. 28, 2002

(54) Performance management system and method

(76) Inventor: Yves Patrick Lajouanie, Washington, DC (US)

Correspondence Address: BAKER & MCKENZIE, 805 THIRD AVENUE, NEW YORK, NY, 10022, US

(21) Appl. No.: 09/862,871

(22) Filed: May 22, 2001

(51) Int. Cl. G06F 17/60

(52) U.S. Cl. 705/7

(57) ABSTRACT

Method for monitoring a performance of a business activity. The method includes analyzing the business activity and selecting at least one predefined business performance model from a plurality of predefined business performance models that satisfactorily monitors the performance of the business activity.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### FIELD

The present application generally relates to a performance management system and method and, more particularly, to a system and method for monitoring and managing the performance of a business activity using one or more predefined business performance models and one or more graphical interfaces.

### BACKGROUND INFORMATION

Software applications are available which allow for the modeling of business processes. The software applications use metrics for representing the performance of the business process. In order to determine the performance of the business process, a bottom-up approach is utilized, whereby each of the components on which the business process relies are first determined and metrics measure the performance of these individual components. For example, a performance determination is made whether network lines are working properly, whether databases are working properly and whether applications are working properly.

There is a need for a system and method having a top-down approach for monitoring and managing the performance of one or more business activities, that is, an approach that analyzes performance criteria, for example, business commitments, of an individual or company incorporating the business activities. A need also exists for monitoring and managing the performance of one or more business activities using predefined business performance models and pre-developed graphical representations for displaying performance data in a particular way according to predefined categories of users.

### SUMMARY OF THE INVENTION

An aspect of the present application provides for a method for monitoring a performance of a business activity. The method includes analyzing the business activity, and selecting at least one predefined business performance model from a plurality of predefined business performance models for monitoring the performance of the business activity.

Another aspect of the present application provides for a method for monitoring a performance of a business activity, including analyzing the business activity, selecting at least one predefined business performance model from a plurality of predefined business performance models for monitoring the performance of the business activity, and selecting a predefined category of users from a plurality of predefined category of users.

An additional aspect of the present application provides for a method for selecting a business performance model. The method includes analyzing at least one performance criteria of a business activity, and selecting the business performance model from a plurality of business performance models at least based on the at least one performance criteria.

A further aspect of the present application provides for a method for viewing performance data of a business activity, including developing at least one business performance model based on at least one performance criteria, and generating the performance data by using the at least one developed business performance model.

A still further aspect of the present application provides for a system for monitoring a performance of a business activity, including an interface associated with a user device for viewing performance data associated with the business activity, and a server operable to store at least one predefined business performance model and to generate the performance data using the predefined business performance model.

Another aspect of the present application provides for a system for monitoring a performance of a business activity. The system includes a processor for generating performance data using a predefined business performance model, and an interface for displaying the performance data.

An additional aspect of the present application provides for a method for monitoring a performance of a business activity. The method includes analyzing the business activity, and selecting at least one predefined business performance model from a plurality of predefined business performance models for monitoring the performance of the business activity, each predefined business performance model associated with at least one performance criteria.

### BRIEF DESCRIPTION OF THE DRAWINGS

FIG. 1 illustrates a block diagram of a business activity and predefined business performance models;

FIG. 2 illustrates a block diagram of a business activity and predefined business performance models;

FIG. 3 illustrates a block diagram of a predefined business performance model and predefined users;

FIG. 4 illustrates exemplary graphical representations including performance data;

FIG. 5 illustrates exemplary graphical representations including performance data; FIG. 6 illustrates exemplary graphical representations including performance data;

FIG. 7 illustrates exemplary sub-processes of a predefined business performance model and associated business performance metrics;

FIG. 8 illustrates exemplary sub-processes of a predefined business performance model and associated business performance metrics;

FIG. 9 illustrates exemplary sub-processes of a predefined business performance model and associated business performance metrics;

FIG. 10 illustrates a mortgage business process and associated predefined business performance models; and

FIG. 11 illustrates an exemplary system for monitoring a performance of a business activity.

### DETAILED DESCRIPTION

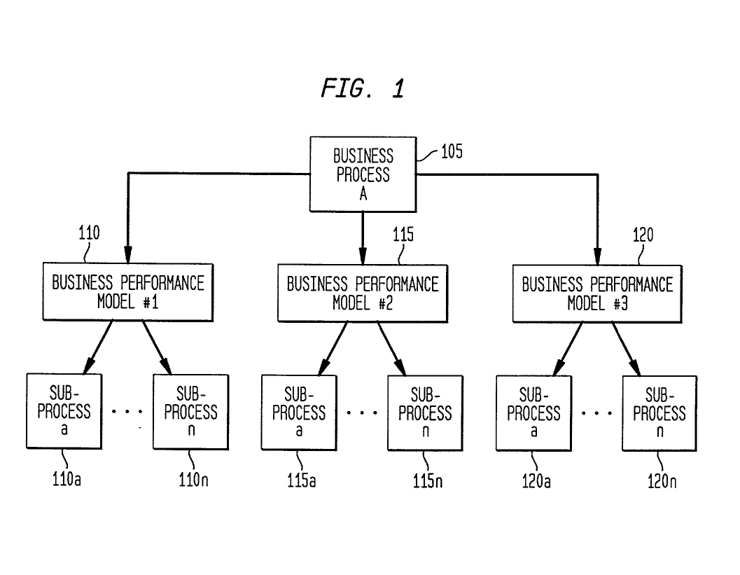

The exemplary block diagram of FIG. 1 illustrates the selection of a predefined business performance model for a particular business activity. In the exemplary embodiments of the present application, every business activity can be segregated into one or more predefined business performance models, which may also include one or more predefined sub-processes, that satisfactorily monitor the performance of the particular business activity. Even though the exemplary embodiments are described with reference to selecting from three predefined business performance models, more or less predefined business performance models can be developed and selected. The predefined business performance models can be implemented using one or more software applications. In addition, the exemplary embodiments are described with reference to business processes which are merely examples of business activities. Any business activity can be monitored and managed regardless of whether the business activity includes a series of successive steps as in a business process.

Each predefined business performance model is developed based on at least one or more performance criteria, for example, business commitments, of an individual or company, such as punctuality, fluidity, accessibility and response-time. Performance criteria includes any information which would satisfactorily validate that a business activity is performing in compliance with an expected behavior. For example, a company may have a business activity that includes an interactive web site and the company may desire to know whether the web site is accessible at particular hours of the day and provides responses promptly. Examples of performance criteria which may be important to the company include accessibility and response-time. One or more predefined business performance models appropriate for monitoring such performance criteria could be used by the company to monitor and manage the performance of the business activity.

In the exemplary embodiments of the present application, predefined business performance model #1 110 is referred to as an on-line business performance model, predefined business performance model #2 115 is referred to as a straight-through business performance model and predefined business performance model #3 120 is referred to as a cut-off business performance model. The names of the predefined business performance models are merely illustrative and are not meant to limit the functionality of the respective business performance model. The on-line business performance model can be used to monitor the performance of business activities involving multiple users accessing a service in real-time in order to perform immediate transactions, for example, on-line trading. As a result, the on-line business performance model satisfactorily monitors the performance of the business activities having performance criteria such as accessibility and response-time. The straight-through business performance model can be used to monitor the performance of business activities involving flows of data having to be processed through a series of applications and then distributed to internal/external parties, for example, order routing and order management. Accordingly, the straight-through business performance model satisfactorily monitors the performance of a business activity having performance criteria such as fluidity. The cut-off business performance model monitors the performance of business activities involving operations that need to be completed before a predetermined deadline, for example, electronic funds transfers, and, thus, the performance criteria is, for example, punctuality.

Upon evaluating business process A 105 shown in FIG. 1, either predefined business performance model #1 110, predefined business performance model #2 115 or predefined business performance model #3 120 is selected based on one or more performance criteria of business process A 105 and that will thus satisfactorily monitor the performance of business process A 105. The evaluation of business process A 105 and the selection of predefined business performance models 110, 115, 120 is performed by one or more individuals. Alternatively, the evaluation and selection can be performed using one or more software applications.

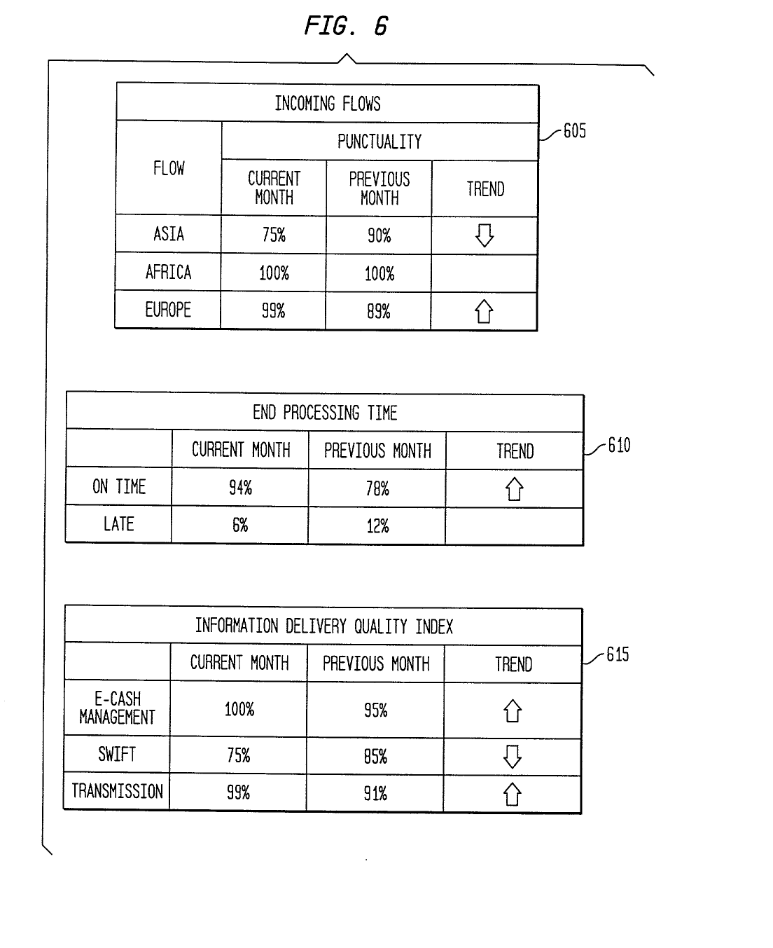

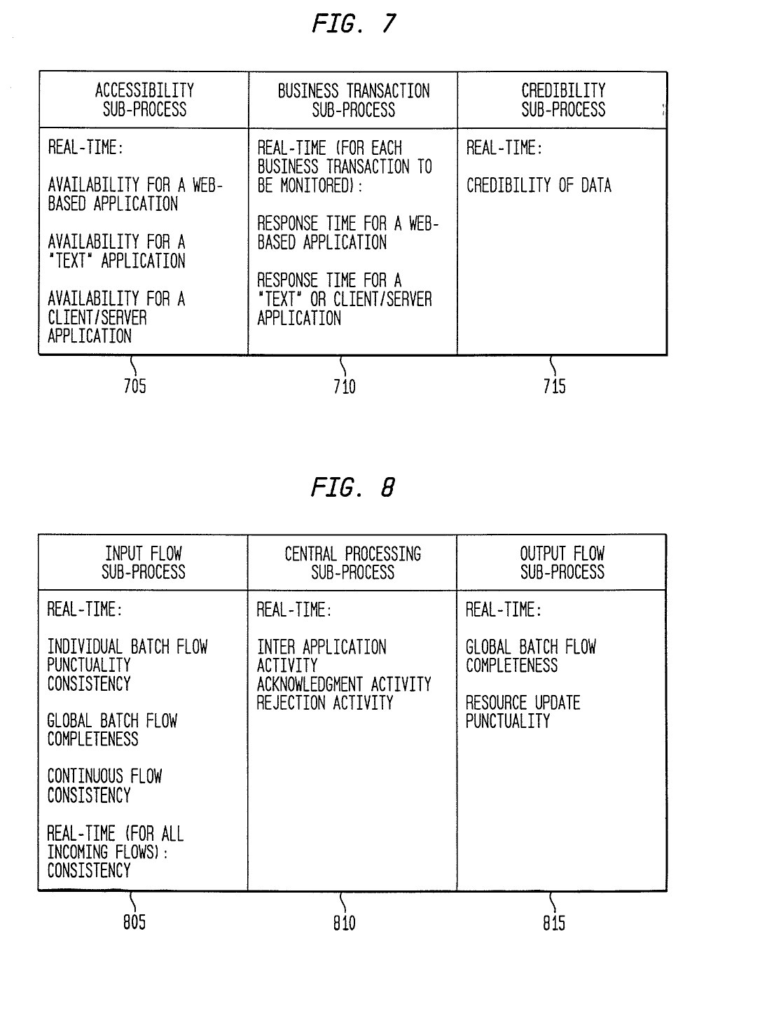

The selected predefined business performance model 110, 115, 120 includes one or more sub-processes. Alternatively, one or more of the predefined business performance models does not include any sub-processes. In particular, predefined business performance model #1 110 includes one or more sub-processes 110a . . . 110n, predefined business performance model #2 115 includes one or more sub-processes 115a . . . 115n and predefined business performance model #3 includes one or more sub-processes 120a . . . 120n, as shown in FIG. 1. FIGS. 7, 8 and 9, described below in greater detail, set forth exemplary sub-processes of predefined business performance model #1 110 (the on-line business performance model), exemplary sub-processes of predefined business performance model #2 115 (the straight-through business performance model) and exemplary sub-processes of predefined business performance model #3 120 (the cut-off business performance model), respectively.

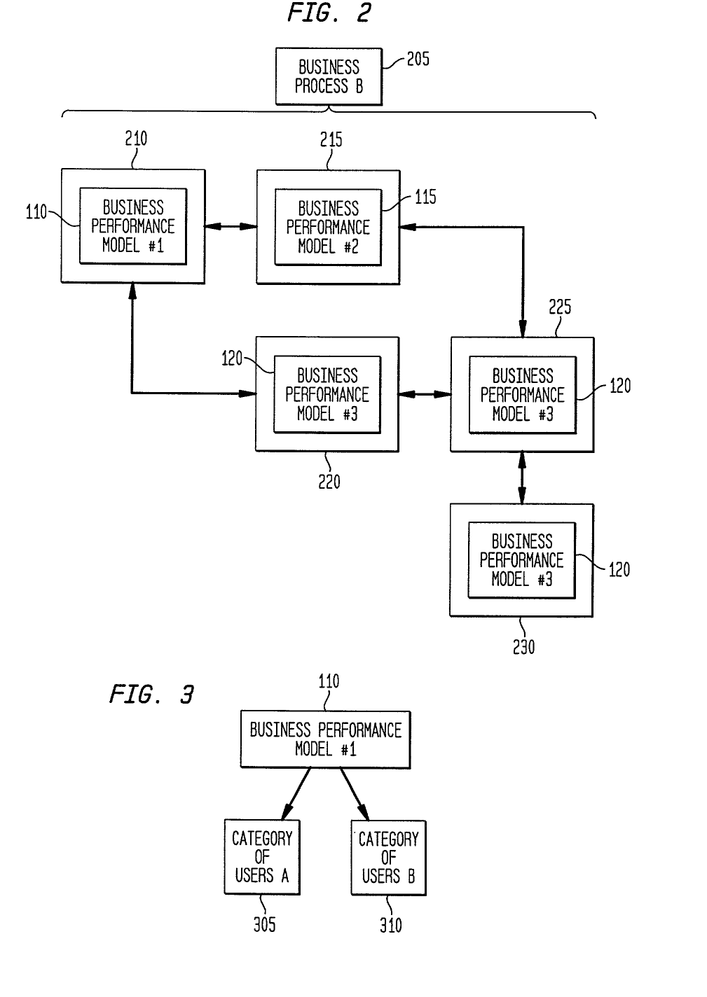

Alternatively, a business process may include multiple business processes and therefore be capable of being segregated into more than one predefined business performance model. As shown in FIG. 2, business process B 205 is comprised of, for example, five business processes integrated together. The five business processes include business process 210, business process 215, business process 220, business process 225 and business process 230. Upon evaluating the multiple business processes of business process B 205, one of the three predefined business performance models 110, 115, 120 is selected for each of the business processes 210, 215, 220, 225, 230. For example, FIG. 2 illustrates that predefined business performance model #1 110 is selected for business process 210, predefined business performance model #2 115 is selected for business process 215, predefined business performance model #3 120 is selected for business process 220, predefined business performance model #3 120 is selected for business process 225 and predefined business performance model #3 120 is selected for business process 230. Each of the predefined business performance models 110, 115, 120 are selected based on one or more performance criteria of business processes 210, 215, 220, 225, 230 and that will thus satisfactorily monitor the performance of the respective business process. For example, business process performance model #1 110, the on-line business performance model, is selected for business process 210 since business process 210 involves at least accessibility and response-time performance criteria.

Each of the predefined business performance models 110, 115, 120 allow for the monitoring and managing of the performance of one or more business activities. In an exemplary embodiment, in order for a user to monitor and manage the performance of one or more business activities, one or more pre-developed graphical representations, referred to herein as pre-developed dashboards, display performance data. Particular pre-developed dashboards displaying particular performance data in particular ways are viewable by predefined categories of users and are selected from a library of pre-developed dashboards. Multiple pre-developed dashboards can display the same performance data, but in different ways, for example, in graphical format or table format, or can display the same performance data the same ways. In an alternative embodiment, any pre-developed dashboard is viewable by any predefined category of users. Dashboards can also be custom developed depending on, for example, certain demands or desires of an individual or company. There can also be more than one version of a particular pre-developed dashboard viewable by predefined categories of users, for example, different versions showing different degrees of detail of the same performance data.

Upon one of the predefined business performance models 110, 115, 120, for example, predefined business performance model #1 110, being selected, a predefined category of users is selected before selecting one of the pre-developed dashboards for displaying performance data. For example, as shown in FIG. 3, upon predefined business performance model #1 110 being selected for a particular business process, category of users A 305 or category of users B 310 is selected. Depending on which category of users 305, 310 is selected, certain performance data is displayed in a particular way on one or more pre-developed dashboards selected from a library of pre-developed dashboards for the respective category of users to view. A pre-developed dashboard displays performance data, but can also display other data. In an exemplary embodiment, category of users A 305 includes individuals such as operations control room staff or employees who may need early warning information to identify abnormal situations as soon as such situations appear and to manage operational risk in real-time. Category of users B 310 includes individuals such as executives of a company who may need summarized information and trends to manage the relationship with internal and external parties and to improve operational efficiency. Further, individuals in category of users B 310 may need real-time information when critical situations arise. Additional categories of users and pre-developed dashboards can be created and, therefore, the present application is not limited to predefined category of users A 305 and predefined category of users B 310. Moreover, the above-identified individuals included in category of users A and category of users B are merely illustrative.

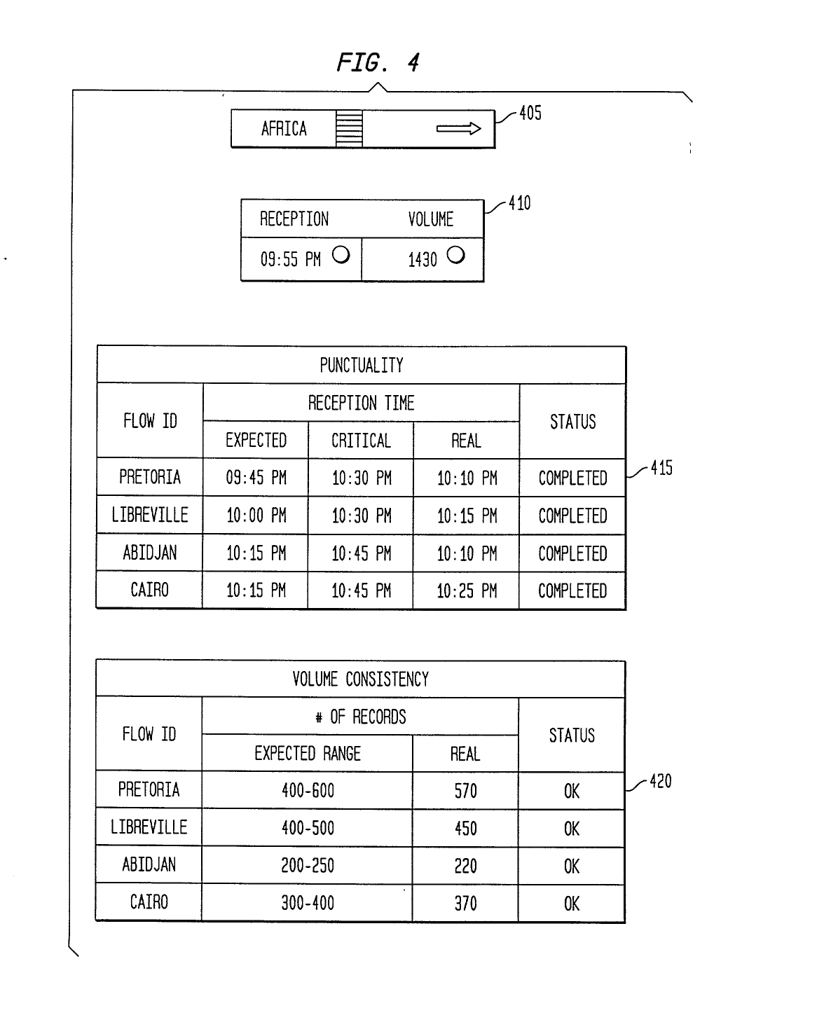

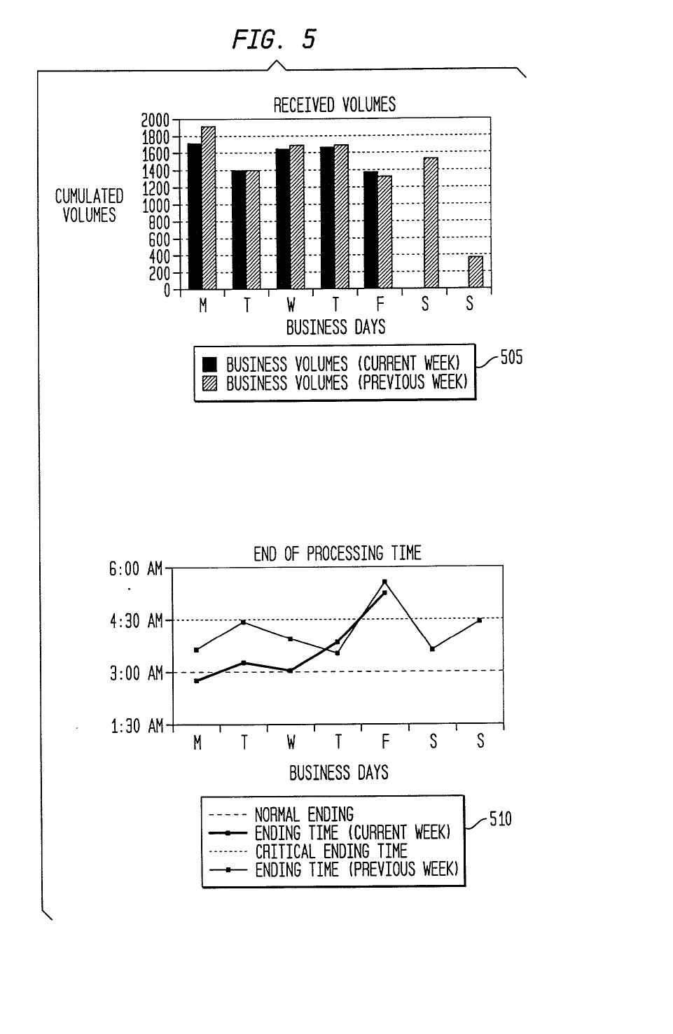

FIG. 4 illustrates a pre-developed dashboard 405, 410, 415, 420 viewable by one or more users in category of users A 305, for example, an individual in a control room. The dashboard shown in FIG. 4 relates to predefined business performance model #3 120, the cut-off business performance model. As can be seen in FIG. 4, the control room user can monitor and manage performance data such as labels and icons 405, for example, location data, status summary data 410, for example, reception time and volume, and detailed status data 415, for example, punctuality data and volume consistency data. Similarly, FIGS. 5 and 6 illustrate pre-developed dashboards viewable by one or more users in category of users B 310, for example, an executive of a company. The pre-developed dashboards 505, 510, 605, 610, 615 shown in FIGS. 5 and 6 also relate to predefined business performance model #3 120, the cut-off business performance model. As can be seen in FIGS. 5 and 6, the executive can view performance data such as received volumes data, end of processing time data, incoming flows data, end processing time data and information delivery quality index data.

In an exemplary embodiment, every user who desires to monitor and to manage the performance of one or more business activities is categorized into one of the two predefined category of users 305, 310. As a result of being categorized as one of the two predefined category of users 305, 310, only particular performance data is viewable in a particular way on one or more pre-developed dashboards by a respective user in the respective category. The same performance data may be viewable by one or more users in both predefined category of users 305, 310, but may be displayed in different formats. In an alternative embodiment, users in each predefined category of users 305, 310 can view all performance data relating to a business process displayed on one or more pre-developed dashboards.

In an exemplary embodiment, pre-developed dashboards display performance data associated with a business activity according to metrics, or calculations made, in one or more sub-processes of a selected predefined business performance model. Each predefined business performance model 110, 115, 120 is associated with predetermined metrics. FIGS. 7 through 9 illustrate some exemplary metrics assigned to predefined business performance model #1 110, predefined business performance model #2 115 and predefined business performance model #3 120, respectively.

In an exemplary embodiment, metrics measure how a business activity, for example, a business process or sub-process, is performing or behaving through time, predict how a business activity is likely to perform and/or how well resources of the business activity are utilized. In order for metrics to measure how a process or sub-process is performing through time, measurements are made and recorded periodically for comparison. The performance of a business activity often varies in time in reflection of changing demands on the business activity, and changes in the individual people and tools used in the business process.

FIG. 7 illustrates accessibility sub-process 705, business transaction sub-process 710 and credibility sub-process 715, and examples of metrics included within each sub-process, for predefined business performance model #1 110, the on-line business performance model. More or less sub-processes and metrics within each sub-process can be utilized. In an exemplary embodiment, the metrics are characterized by the type of user interface a user will use to access services. The type of user interfaces are, for example, browser graphical user interfaces (“GUI”) for web-enabled applications, windows GUI for client/server applications and text screen GUI for on-line transaction processing (“OLTP”) applications run on a mainframe server. Further, performance criteria for the on-line business performance model which are desirable to monitor include, for example: is a service accessible?; is the performance of the service correct?; and is the information correct and consistent?

The following description of the metrics within each sub-process shown in FIGS. 7 through 9 is merely exemplary. Other metrics for monitoring and managing the performance of a business activity can be used in place of or in addition to the metrics described.

In accessibility sub-process 705, availability for a web-enabled application from external and internal providers is determined. Specifically, connection to an Internet service provider and access to a home web page are checked via an http or https data source. Availability for a text application is determined according to accessibility to a main menu of an application from a customer local area network via a full screen data source, and availability for a client/server application is determined according to accessibility to a main menu of an application via data provided by any tool such as homemade scripts or application test software.

In business transaction sub-process 710, actual external and actual internal response time for a web-based application is compared to low and high thresholds, and actual response time for a text or client/server application is compared to low and high thresholds. Measurements are made every predetermined number of minutes. In credibility sub-process 715, credibility of data is performed for each business transaction. In particular, consistency of data versus a pattern is determined. For example, if an on-line trading activity is being monitored, the displayed value of a stock is checked to validate that the value is being updated and/or that the value is between a minimum and maximum number, such as +/−20 percent of the previous day value.

FIG. 8 illustrates input flow sub-process 805, central processing sub-process 810 and output flow sub-process 815, and examples of metrics included within each sub-process, for predefined business performance model #2 115, the straight-through business performance model. More or less sub-processes and metrics within each sub-process can be utilized. Input flows for a straight-through business activity are all the flows of data that feed a straight-through activity, for example, from file transfers, and may feed the activity all day. Performance criteria for input flows that are desirable to monitor include, for example: have all files been received?; are the file sizes consistent?; are the files error-free?; are the volumes of incoming messages consistent?; and do volumes match a business day profile? Central applications for a straight-through business activity process input flows to deliver transformed data to internal/external parties. Performance criteria for central applications that are desirable to be monitored include, for example: is data flowing smoothly between applications?; is there any pending acknowledgements between applications?; and are the rejection rates consistent? Output flows for a straight-through business activity are the flows of data resulting from the central applications and have to be sent to other parties or applications. Performance criteria for output flows that are desirable to be monitored include, for example: are output messages being sent to the appropriate channels?; and were acknowledgements received?

In input flow sub-process 805, punctuality and consistency of an individual batch flow, completeness for a global batch flow and consistency for a continuous flow are monitored in real-time. Specifically, punctuality of an individual batch is determined by comparing arrival time of an input flow versus normal and critical expected arrival time, and consistency is determined by examining actual volume (size or number of records) of input flow within a minimum and/or maximum range. Completeness of a global batch flow is determined by number of files arrived before a predetermined time and number of files arrived at a predetermined time compared to a minimum and/or maximum range. Consistency of a continuous flow is determined by volume received for n minutes compared to a minimum and/or maximum range. In addition, consistency for all incoming flows is determined real-time by comparing total received volume (absolute value) versus a minimum and a maximum expected volume.

In central processing sub-process 810, inter application activity, acknowledgment activity and rejection activity is determined real-time. Inter application activity is determined, for example, within two applications, by comparing received messages and/or sent messages versus an expected ratio. Acknowledgment activity is determined by comparing number pending for acknowledgment versus a threshold. Rejection activity is determined by comparing number of rejected messages versus a threshold.

In output flow sub-process 815, completeness for global batch flow and punctuality for resource update are determined real-time for each output flow. Completeness for global batch flow is determined by comparing number of files sent compared with number of files to be sent, and/or number of files acknowledged compared to number of files to be acknowledged. Punctuality of updates for each resource to be updated is determined by comparing the actual update versus the expected update time.

FIG. 9 illustrates input flow sub-process 905, central processing sub-process 910 and output flow sub-process 915, and IS examples of metrics included within each sub-process, for predefined business performance model #3 120, the cut-off business performance model. More or less sub-processes and metrics within each sub-process can be utilized. Input flows for a cut-off business activity are all the flows of data from, for example, file transfers or database record inputs, that feed a central process and are needed before the central process starts. Performance criteria for input flows that are desirable to be monitored include, for example: have all files been received?; did the files arrive on time?; are the file sizes consistent?; are the files error-free?; and are the volumes of records or messages consistent? Central processing for a cutoff business activity can be a series of batch jobs, running on one or several systems, that have to be finished at a predetermined time. Performance criteria for central processing that are desirable to be monitored include, for example: are jobs on-time?; and are there any jobs ending abnormally?

In input flow sub-process 905, punctuality and consistency of an individual batch flow, completeness for a global batch flow and consistency for a continuous flow are monitored in real-time. Specifically, punctuality of an individual batch is determined by comparing arrival time of an input flow versus normal and critical expected arrival time, and consistency is determined by examining actual volume (size or number of records) of input flow within a minimum and/or maximum range. Completeness of a global batch flow is determined by the number of files arrived before batch start time and the number of files arrived at start time compared to a minimum and/or maximum range. Consistency of a continuous flow is determined by volume arrived before batch start time and volume arrived at start time compared to a minimum and/or maximum range. In addition, consistency for all incoming flows is determined real-time by comparing total received volume (absolute value) versus a minimum and a maximum expected volume.

In central processing sub-process 910, punctuality and quality is monitored real-time for each job. Availability is monitored real-time for each piece of information that needs to be available for central processing to be considered finished. Punctuality, for example, compliance with deadlines is determined by comparing actual start time versus normal start time, and by comparing actual end time versus normal and critical end time. Quality, for example, job status, is monitored by detecting abnormal ends. Availability, for example, information availability, is monitored by two checks of availability of a critical piece of information, such as normal avail time and critical avail time.

In output flow sub-process 915, completeness for global batch flow and punctuality for resource update are determined real-time for each output flow. Completeness for global batch flow is determined by comparing number of files sent compared with number of files to be sent, and/or number of files acknowledged compared to number of files to be acknowledged. Punctuality of updates for each resource to be updated is determined by comparing the actual update versus the expected update time.

Further, in an exemplary embodiment, each of the predefined business performance models 110, 115, 120 can monitor the performance of infrastructure associated with a particular business activity and, thus, allow one or more users within the categories of users 305, 310 to manage the infrastructure accordingly. For example, information can be provided to users via one or more pre-developed dashboards regarding the availability of underlying infrastructure components such as servers, job schedulers, file transfer tools, database engines, input and output logical channels, routers and firewalls. Moreover, the performance of underlying infrastructure components can be monitored and managed.

The following example for segregating a mortgage business process into more than one business process model is purely exemplary and is not meant to limit the present application in any way. Rather, any business process can be applied to the embodiments of the present application.

The mortgage business process can be subdivided into multiple business processes, in particular, a mortgage pricing business process, a mortgage approval business process, mortgage processing business process and a mortgage electronic funds transfer business process. An individual desiring a mortgage directs inquiries about the mortgage to, for example, an on-line bank, a lending company or a local bank. The bank or lending company submits a mortgage application to a back-office operations center. The center provides to the individual mortgage product and pricing information as a result of a mortgage pricing business process. A mortgage request then undergoes a mortgage approval process which includes mortgage product and pricing information, credit report information and an adjudication process. Next, the mortgage is processed using a mortgage processing business process including mortgage compliance documentation exchange, a document fulfillment process and a document archiving process. After the mortgage is processed, an mortgage electronic funds transfer business process transfers the funds to, for example, the bank.

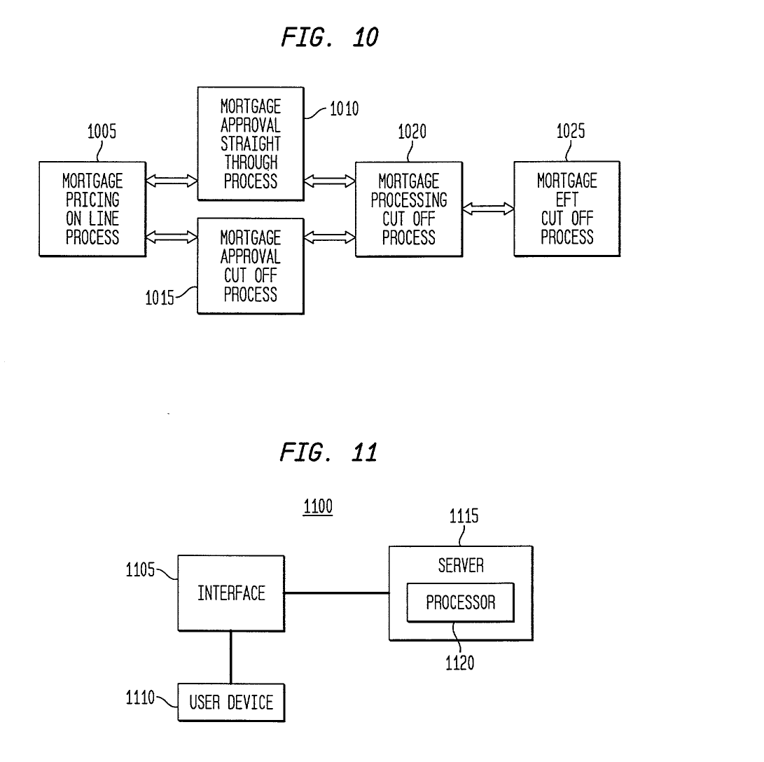

The mortgage business process is evaluated and segregated into multiple business processes, and predefined business performance models 110, 115, 120 are selected that can satisfactorily monitor the performance of the business processes by analyzing performance criteria such as business commitments. FIG. 10 illustrates the predefined business performance models 110, 115, 120 selected for each of the business processes of the mortgage business process. Specifically, the mortgage business process is segregated into a mortgage pricing business process 805, mortgage approval business process 1010, mortgage approval business process 1015, mortgage processing business process 1020 and mortgage electronic funds transfer business process 1025. Thereafter or concurrently therewith, a determination is made as to which of the predefined business performance models 110, 115, 120 relates to the respective business process. As shown in FIG. 10, predefined business performance model #1 110, for example, the on-line business performance model, is used for the mortgage pricing business process 1005, predefined business performance model #2 115, for example, the straight-through business performance model, is used for one of the mortgage approval business processes 1010, predefined business performance model #3 120, for example, the cut-off business performance model, is used for the other mortgage approval business process 1015, the cut-off business performance model is used for the mortgage processing business process 1020 and the mortgage electronic funds transfer business process 1025. Thus, one of the predefined business performance models 110, 115, 120 are used for each of the business processes comprising the mortgage business process.

The on-line business performance model is used for the mortgage pricing business process 1005 because of the rapid turnaround between the submission of a mortgage request and the mortgage pricing information provided to the individual, such as amount of principal and interest to be paid monthly. Either the straight-through business performance model and/or the cut-off business performance model is used for the mortgage approval process depending on the mortgage product type. Specifically, the straight-through business performance model is used for the mortgage approval business process 1010 when multiple mortgages need approval by checking, for example, the financial history of each individual requesting the respective mortgage. On the other hand, the cut-off business performance model is used for mortgage approval business process 1015 when the approval of a mortgage occurs quickly, for example, by the next business day. The cut-off business performance model is used for the mortgage processing business process 1020 and the mortgage electronic funds transfer business process 1025 because mortgage often need to be processes within a predetermined amount of time and funds need to be transferred on or by a particular day, respectively.

Any other business activity can similarly be segregated into one or more business activities and predefined business performance models can then be associated with the one or more business activities.

In a further exemplary embodiment, a system 1100 is used for monitoring the performance of a business activity. The system 1100 includes an interface 1105, for example, a software application, associated with a user device 1110, for example, a personal computer, and a server 1115. The interface 1105 allows for viewing performance data associated with the business activity and the server 1115 including a processor 1120 is operable to store at least one predefined business performance model and to generate the performance data using the predefined business performance model. Systems other than client server systems can also be used for monitoring and managing a performance of a business activity.

It should be noted that performance data can be provided to a user, for example, from one of the categories of users 305, 310, via a web-enabled graphical user interface, e-mail, pager, land-line telephone, cellular telephone, facsimile or via any other communication media.

The embodiments described above are illustrative examples of the present invention and it should not be construed that the present invention is limited to these particular embodiments. Various changes and modifications may be effected by one skilled in the art without departing from the spirit or scope of the invention as defined in the appended claims.

What is claimed is:

1. A method for monitoring a performance of a business activity, comprising:
analyzing the business activity; and
selecting at least one predefined business performance model from a plurality of predefined business performance models for monitoring the performance of the business activity.

2. The method for monitoring a performance of a business activity as set forth in claim 1, wherein
the plurality of predefined business performance models is a first business performance model, a second business performance model and a third business performance model.

3. The method for monitoring a performance of a business activity as set forth in claim 2, wherein
the first business performance model can be used to monitor the performance of at least one business activity involving at least one user accessing a service in order to perform at least one transaction requiring an immediate response.

4. The method for monitoring a performance of a business activity as set forth in claim 2, wherein
the second business performance model can be used to monitor the performance of at least one business activity involving a flow of data having to be processed through at least one application and then distributed.

5. The method for monitoring a performance of a business activity as set forth in claim 2, wherein
the third business performance model can be used to monitor the performance of at least one business activity involving at least one operation that needs to be completed before a predetermined time.

6. The method for monitoring a performance of a business activity as set forth in claim 2, wherein
the first business performance model, the second business performance model and the third business performance model each include a plurality of predefined sub-processes.

7. The method for monitoring a performance of a business activity as set forth in claim 6, wherein
the plurality of predefined sub-processes for the first business performance model, for the second business performance model and for the third business performance model include a first sub-process, a second sub-process and a third sub-process.

8. The method for monitoring a performance of a business activity as set forth in claim 7, wherein
the plurality of predefined sub-processes of the first business performance model, the second business performance model and the third business performance model each include one or more predefined metrics.

9. The method for monitoring a performance of a business activity as set forth in claim 1, wherein the business activity is a business process.

10. A method for monitoring a performance of a business activity, comprising:
analyzing the business activity;
selecting at least one predefined business performance model from a plurality of predefined business performance models for monitoring the performance of the business activity; and
selecting a predefined category of users from a plurality of predefined category of users.

11. The method for monitoring a performance of a business activity as set forth in claim 10, further comprising:
generating an interface based on at least the selected at least one predefined business performance model and the selected predefined category of users for illustrating the performance of the business activity.

12. The method for monitoring a performance of a business activity as set forth in claim 11, wherein
the interface is selected from a plurality of predefined interfaces.

13. The method for monitoring a performance of a business activity as set forth in claim 10, wherein
the business activity is a business process.

14. A method for selecting a business performance model, comprising:
analyzing at least one performance criteria of a business activity; and
selecting the business performance model from a plurality of business performance models at least based on the at least one performance criteria.

15. The method for monitoring a performance of a business activity as set forth in claim 14, wherein
the business activity is a business process.

16. A method for viewing performance data of a business activity, comprising:
developing at least one business performance model based on at least one performance criteria; and
generating the performance data by using the at least one developed business performance model.

17. A system for monitoring a performance of a business activity, comprising:
an interface associated with a user device for viewing performance data associated with the business activity; and
a server operable to store at least one predefined business performance model and to generate the performance data using the predefined business performance model.

18. The system for monitoring a performance of a business activity as set forth in claim 17, wherein the predefined business performance model includes at least one metric.

19. The method for monitoring a performance of a business activity as set forth in claim 17, wherein
the business activity is a business process.

20. A system for monitoring a performance of a business activity, comprising:
a processor for generating performance data using a predefined business performance model; and
an interface for displaying the performance data.

21. The system for monitoring a performance of a business activity as set forth in claim 20, wherein
the predefined business performance model includes at least one metric.

22. A method for monitoring a performance of a business activity, comprising:
analyzing the business activity; and
selecting at least one predefined business performance model from a plurality of predefined business performance models for monitoring the performance of the business activity, each predefined business performance model associated with at least one performance criteria.

23. The method for monitoring a performance of a business activity as set forth in claim 22, wherein
the at least one performance criteria of one of the plurality of predefined business performance models is response time which allows for monitoring the response time of the business activity.

24. The method for monitoring a performance of a business activity as set forth in claim 22, wherein
the at least one performance criteria of one of the plurality of predefined business performance models is fluidity which allows for monitoring the flow of data of the business activity.

25. The method for monitoring a performance of a business activity as set forth in claim 22, wherein
the at least one performance criteria of one of the plurality of predefined business performance models is completion time which allows for monitoring the completion of one or more operations by a predetermined time.
